(19) United States
(12) Patent Application Publication
(10) Pub. No.: US 2024/0139566 A1
(43) Pub. Date: May 2, 2024

(54) Fire Suppression Device and Method of Use Thereof

(71) Applicant: Christopher Smith, Yucaipa, CA (US)

(72) Inventor: Christopher Smith, Yucaipa, CA (US)

(21) Appl. No.: 18/158,797

(22) Filed: Jan. 24, 2023

Related U.S. Application Data
(60) Provisional application No. 63/420,172, filed on Oct. 28, 2022.

(51) Int. Cl. A62C 5/02; A62C 3/02; A62C 37/40

(52) U.S. Cl. CPC A62C 5/022; A62C 3/0214; A62C 37/40

(57) ABSTRACT

The present invention relates to a novel fire suppression device for prohibiting fire and preventing same from spreading. The device is compact and is configured to autonomously release type A or type B fire-retardant foam for covering a structure such as a building or portions thereof. The device includes a plurality of components, including a water reservoir, a foam concentrate reservoir, an oxygen reservoir, and an aerator for forming fire-retardant foam. In one embodiment, the device includes a sensor for detecting excessive temperature, smoke, or fire for autonomously actuating the device. In another embodiment, the device is manually activated by a user. The device can be used with new or existing buildings, designated fire (i.e., fireplace) spaces, and/or cook areas as well.

### CROSS-REFERENCE TO RELATED APPLICATION

The present application claims priority to, and the benefit of, U.S. Provisional Application No. 63/420,172, which was filed on Oct. 28, 2022, and is incorporated herein by reference in its entirety.

### FIELD OF THE INVENTION

The present invention relates generally to the field of fire extinguishers. More specifically, the present invention relates to a novel fire suppression device configured to autonomously release fire-retardant foam for preventing and suppressing fire. The device is autonomously activated or actuated upon detecting very high temperature, fire, or smoke for forming and releasing fire-retardant foam. The device can be used in homes and businesses and can also be used for wild (i.e., brush) fires. The device may come in a variety of designs and structures to effectively suppress fire. Accordingly, the present disclosure makes specific reference thereto. Nevertheless, it is to be appreciated that aspects of the present invention are also equally applicable to other like applications, devices, and methods of manufacture.

### BACKGROUND

By way of background, housefires are common across the globe and when fires burn down homes and businesses, they cause significant economic losses, also referred to as property damage. In fact, in 2020, home fires across the U.S. resulted in an estimated $7.3 billion in direct property damage. Causes of housefires include unattended cooking, grease fires, short circuits due to faulty wiring, candles, holiday decorations/lighting, unattended fireplaces, and more. Space heaters used in homes and businesses may also cause fire when items susceptible to easily catch fire including curtains, laundry, blankets, and furniture are kept near, or come into contact with, the space heaters.

Firepits, campfires, or cooking areas/grills are commonly utilized by humans. Human-caused fires result from unattended firepits, campfires, outdoor cooking elements, burning of debris, equipment use and malfunctions, negligently discarded cigarettes, fireworks, and intentional acts of arson. Lightning is one of the two natural causes of fires.

For preventing fires in homes, structures, and businesses, individuals install smoke alarms for raising an alarm when smoke or fire is detected. Individuals also try to be careful while smoking, keep combustible things away from walls and corners, and more. The most common method of extinguishing a fire is use of a garden hose or small fire extinguisher. However, conventional fire extinguishers require a person to manually activate and operate them. Many times, individuals may be unaware of the fire, which can cause delay in use of such extinguishers. In many scenarios, individuals do not have knowledge of how to operate fire extinguishers. Individuals desire a device other than conventional fire extinguishers for enabling them to easily extinguish a structure fire or prohibit same from spreading.

Firepit or designated fire/cook areas are also left without effective efforts or devices for extinguishing by individuals due to lack of effective fire extinguishing products. Individuals desire an improved device for extinguishing fires that spread from designated fire/cook areas.

Therefore, there exists a long-felt need in the art for a device that enables a homeowner to protect their home from fire. There is also a long-felt need in the art for an improved fire extinguishing device that can be used instead of conventional fire extinguishers. Additionally, there is a long-felt need in the art for a fire suppression device that does not require a user to manually activate and operate the device for extinguishing fire. Moreover, there is a long-felt need in the art for a fire suppression device that autonomously protects a home or structure (or portions thereof) from catching on fire. Further, there is a long-felt need in the art for a fire suppression device that reduces losses caused due to house fires and structure fires. Finally, there is a long-felt need in the art for a fire suppression device that autonomously prevents fire in the area around a home or structure and does not require physical presence of a user for operating the device.

The subject matter disclosed and claimed herein, in one embodiment thereof, comprises a fire suppression device. The device is designed to be installed on the roof or outside of a home or a building and is configured to be autonomously activated or actuated when a threshold amount of heat, smoke, or fire is detected by an integrated sensor. The device includes a distilled water reservoir for holding distilled water, a foam concentrate reservoir for holding a foam concentrate, an oxygen reservoir for holding oxygen, wherein an aerator receives distilled water mixed with foam concentrate and oxygen for aeration to produce high pressure fire-retardant foam, the fire-retardant foam is autonomously released through an outlet pipe or discharge opening for releasing the foam outside to cover the home or building, or a designated portion thereof, to suppress fire. In one embodiment, the device is manually activated using a push button for releasing the fire-retardant foam.

In this manner, the fire suppression device of the present invention accomplishes all of the forgoing objectives and provides users with a device that can be installed on the roof and around building of a home or business for detecting heat, smoke, or fire to release a fire-retardant foam. The device autonomously protects a building or structure from catching on fire (or prohibits spreading of same) and thus prevents financial damage. The water and fire-retardant foam producing chemical can be refilled in the device for reusability of the device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fire suppression device. The device is designed to be installed on the roof or outside of a home or a building and is configured to be autonomously activated or actuated when a threshold amount of heat, smoke, or fire is detected. The device includes a distilled water reservoir for holding distilled water, a foam concentrate reservoir for holding a foam concentrate (i.e., concentrator), an oxygen reservoir for holding oxygen, wherein an aerator receives distilled water mixed with foam concentrate and oxygen for aeration to produce high pressure fire-retardant foam, the fire-retardant foam is autonomously released through an outlet pipe for releasing the foam outside to cover the home or building, or portions thereof, to suppress fire.

In yet another embodiment, the device has a multi-purpose sensor for detecting the threshold amount of heat, smoke, or fire for autonomously activating the device to produce and release fire-retardant foam.

In yet another embodiment, the foam concentrate can be used for forming Type A foam or Type B foam and the foam concentrate is introduced to the distilled water for forming the fire-retardant foam.

In yet another embodiment, the counter device is weatherproof and has IP68 rating.

The subject matter disclosed and claimed herein, in one embodiment thereof, comprises a fire suppression shield device. The device further comprising a housing including a plurality of chambers, each chamber is configured to store an internal component for forming a fire-retardant foam, the components include a distilled water reservoir for holding a store of distilled water, a foam concentrate reservoir for holding a store of foam concentrate, an oxygen reservoir for holding a store or air/oxygen, an aerator motor for forming high pressure foam from said distilled water, foam concentrate and oxygen wherein the aerator motor is autonomously activated upon a safety sensor detecting high temperature, smoke, or fire. The fire-retardant foam generated by the device is released using an outlet pipe or discharge opening for covering a building, or designated room/area, to suppress the fire.

In yet another embodiment, a method of suppressing or holding the fire and thereby prevent from further spreading is described. The method includes the steps of providing a fire suppression device, the device is configured to produce fire-retardant foam; autonomously activating the device upon detection of excessive fire, smoke, or temperature; autonomously forming fire-retardant foam using an aerator by mixing a store of foam concentrate, a store of water, and a store of air/oxygen; and, releasing fire-retardant foam to cover a structure such as a building, room, or area, to prevent fire from spreading.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a standalone view of one potential embodiment of a fire suppression device of the present invention in accordance with the disclosed architecture;

FIG. 2 illustrates a top-front perspective view of the fire suppression device of the present invention with an open door and lid in accordance with the disclosed architecture;

FIG. 3 illustrates a front perspective view of the fire suppression device of the present invention in accordance with the disclosed architecture;

FIG. 4 illustrates a functional block diagram showing the process of forming fire-retardant foam using the fire suppression device of the present invention in accordance with the disclosed architecture;

FIG. 5 illustrates a flow diagram depicting a process of suppressing fire using the autonomous fire extinguishing device of the present invention in accordance with the disclosed architecture;

FIG. 6 illustrates a flow diagram depicting a process of manual operation of the fire extinguishing device of the present invention in accordance with the disclosed architecture;

FIG. 7 illustrates a perspective view of the fire suppression device of the present invention showing the chambers and components stored in the housing in accordance with the disclosed architecture; and

FIG. 8 illustrates a perspective view showing the fire suppression device installed outside a home for covering the home building, or particular areas, with fire-retardant foam in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that enables a homeowner to protect their home or designated areas from fire. There is also a long-felt need in the art for an improved fire extinguishing device that can be used instead of conventional fire extinguishers. Additionally, there is a long-felt need in the art for a fire suppression device that does not require a user to manually activate and operate the device for extinguishing fire. Moreover, there is a long-felt need in the art for a fire suppression device that autonomously protects a home or room/area from catching on fire. Further, there is a long-felt need in the art for a fire suppression device that reduces losses caused due to house, building, structure fires. Finally, there is a long-felt need in the art for a fire suppression device that autonomously prevents fire in the areas around, or in, a home and does not require physical presence of a user for operating the device.

The present invention, in one exemplary embodiment, is a method of suppressing fire to hold fire and prevent same from further spreading is described. The method includes the steps of providing a fire suppression device, the device is configured to produce fire-retardant foam; autonomously activating the device upon detection of excessive fire, smoke, or temperature; autonomously forming fire-retardant foam using an aerator by mixing foam concentrate, water, and oxygen; and, releasing fire-retardant foam to cover a structure such as a building, or portions thereof, to prevent fire from spreading.

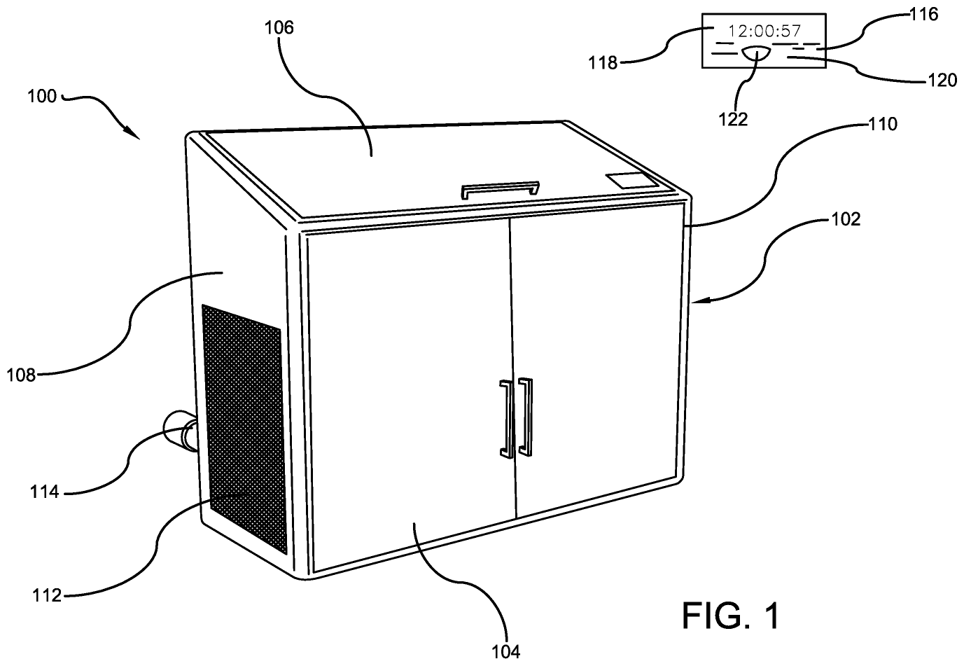

Referring initially to the drawings, FIG. 1 illustrates a standalone view of one potential embodiment of a fire suppression device of the present invention in accordance with the disclosed architecture. The fire suppression device 100 of the present invention is a portable device that can be installed on a roof or around a home or building for providing a fire-retardant foam for preventing/prohibiting the home or building from catching on fire. The device 100 has a housing 102 for storing the necessary components required for generating fire-retardant foam as described later in the disclosure. A front door 104 and a top lid 106 enables a homeowner or an operator to access the stored components therein, wherein the door 104 and the lid 106 also creates a weatherproof structure.

Each of the side walls 108, 110 of the housing 102 has a metal grid 112 for enabling a homeowner to look inside the housing 102 to view a status of the components to prevent any leakage or any other malfunction. For releasing fire-retardant foam, a pipe or discharge opening 114 extends out from the rear wall 114 of the housing 102 wherein the fire-retardant foam is autonomously released by the device 100 upon detecting a high temperature, flame, or smoke. The housing 102 can be made of any lightweight metal, alloy, or heavy-duty plastic for a durable and weatherproof structure.

The lid 106 has a display 116 for displaying current time 118, temperature 120 detected by the device 100, and status 122 indicating working status or malfunction of the fire-retardant foam. The device 100 includes a plurality of sensors for detecting flame, smoke, and temperature as described later in the disclosure.

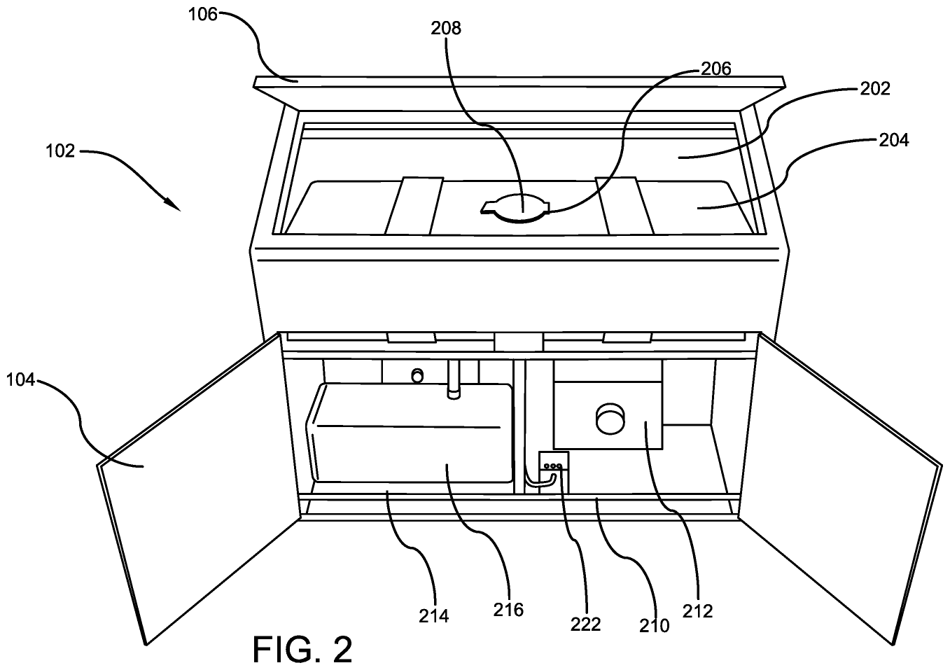

FIG. 2 illustrates a front perspective view of the fire suppression device of the present invention with open door and lid in accordance with the disclosed architecture. The housing 102 includes an upper chamber 202 in which a distilled water reservoir 204 is positioned. The water reservoir 204 stores distilled water used for forming fire-retardant foam and has an opening 206 covered by a circular lid 208. The water reservoir 204, in the preferred embodiment, can store up to ten liters of distilled water. The water reservoir 204 can be a single reservoir or can be a combination of two small reservoirs based on design of the fire suppression device 100.

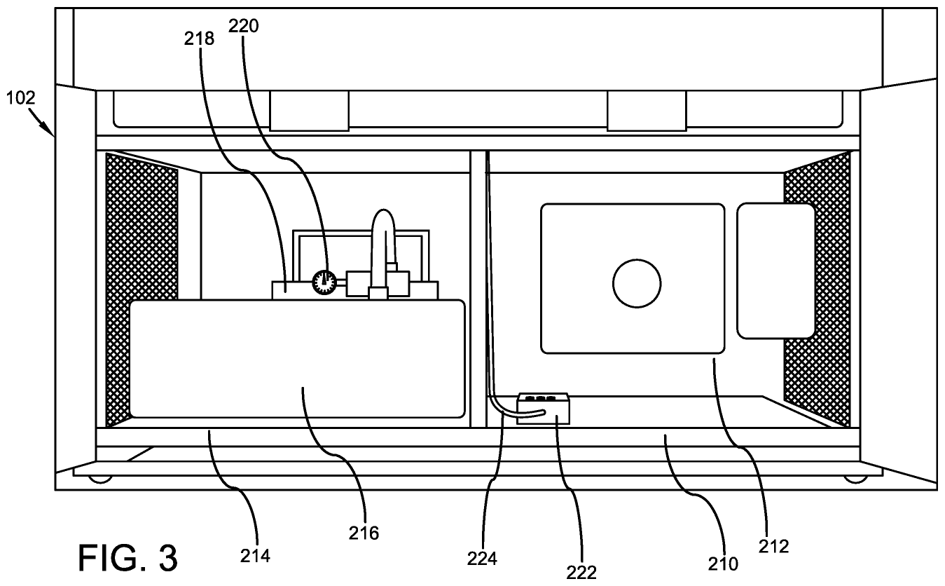

The housing 102 also has a first lower chamber 210 for storing foam concentrate in a foam concentrate reservoir 212. The foam concentrate in the preferred embodiment includes hydrocarbon-based surfactants such as sodium alkyl sulfate, and fluorosurfactants, such as fluorotelomers, perfluorooctanoic acid (PFOA), or perfluorooctanesulfonic acid (PFOS). A second lower chamber 214 includes an air storage 216 for storing air (oxygen) used for making fire-retardant foam. An aeration motor 218 is positioned in the second lower chamber 214 for mixing and aerating the distilled water, foam concentrate, and air in a pressurized manner for creating the fire-retardant foam as illustrated in front view of the device 100 in FIG. 3. The foam is configured to be released from the pipe or discharge opening 114 for covering and surrounding the building, or portion thereof, for preventing same from catching fire.

Based on use and position of the fire-retardant device 100, aeration pressure can be set by a user using pressure meter 220 of the aeration motor 218. Further, for detecting smoke, flame, or high temperature, a multi-purpose safety sensor 222 is positioned in the housing 102 for autonomously detecting a threshold amount of smoke, flame, or temperature. The sensor 222 upon detecting the threshold amount, autonomously activates the device 100 for producing fire-retardant foam as described above.

It should be noted that in some embodiments of the present invention, a push or touch button may be positioned on an appropriate location on the housing 102 for manually activating the device 100 to produce and release fire-retardant foam. The internal components such as the water reservoir 204, foam concentrate reservoir 212, air storage 216, aeration motor 218, and safety sensor 222 of the device 100 are internally connected via electric circuits 224 and other media for autonomously producing foam for release through the pipe or discharge opening 114. The chambers 202, 210, 214 can be integrated or releasably positioned inside the housing 102 and enables a user to access the respective components in order to replace or replenish the stored items.

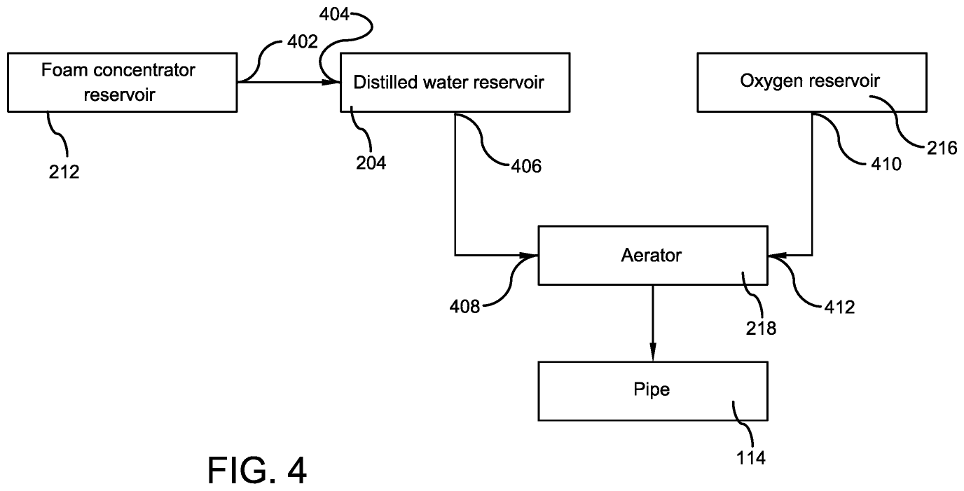

FIG. 4 illustrates a functional block diagram showing the process of forming fire-retardant foam using the fire suppression device of the present invention in accordance with the disclosed architecture. The foam concentrate is released from the outlet 402 of the foam concentrate reservoir 212 towards the inlet 404 of the distilled water reservoir 204 to mix with distilled water. The mixed distilled water from the outlet 406 moves to the aerator 218 along with oxygen from the oxygen reservoir 216 moving from the respective outlet 410 to the inlet 412 of the aerator.

The aerator 218 is configured to perform aeration of the foam concentrate and distilled water to form fire-retardant foam. The fire-retardant foam is then released through the pipe or discharge opening 114 for release in the surrounding area to suppress fire and smoke.

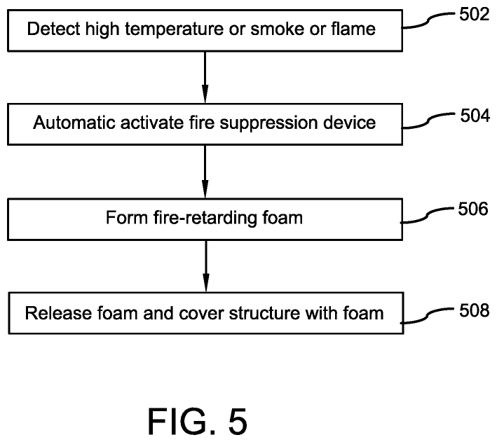

FIG. 5 illustrates a flow diagram depicting a process of suppressing fire using the autonomous fire extinguishing device of the present invention in accordance with the disclosed architecture. Initially, the multi-purpose sensor of the device detects a high temperature, fire, or smoke in and around a building or designated area (Step 502). The device can be kept on a roof or on the ground for easy detection of the fire and smoke. Upon detection of a threshold temperature, smoke, or fire, the device 100 is autonomously activated or actuated, wherein all the components and flow of foam concentrate and oxygen is performed (Step 504). Then, the aerator is activated upon receiving distilled water, foam concentrate, and oxygen to form fire-retardant foam under high pressure (Step 506). Finally, the foam is released from the pipe to cover the surrounding structure with foam to suppress the fire for easy prevention of catastrophic damage to the home (Step 508).

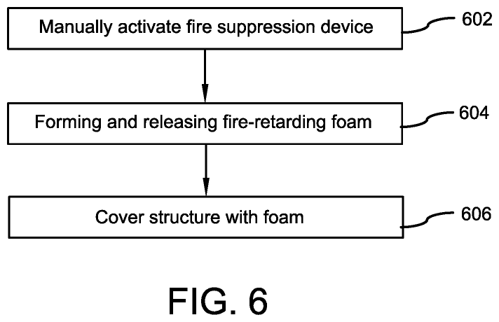

FIG. 6 illustrates a flow diagram depicting a process of manual operation of the fire extinguishing device of the present invention in accordance with the disclosed architecture. Initially, using the push or touch button, the fire suppression device is manually activated by a user such as a homeowner (Step 602). Upon manual activation, the device starts functioning to form fire-retardant foam in an automated manner (Step 604). The formed foam is also released in the surroundings of the device for creating a fire-retardant cover for suppressing and prohibiting fire. The foam is created and released with high pressure using the aerator such that a building or any other structure (or portions thereof) is covered with foam for suppressing the existing fire and for preventing flow of oxygen to feed the fire (Step 606).

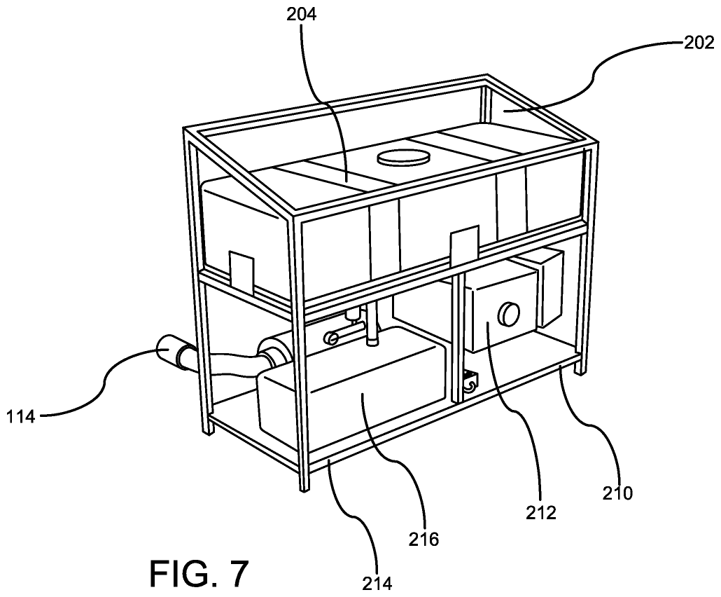

FIG. 7 illustrates a perspective view of the fire suppression device of the present invention showing the chambers and components stored in the housing in accordance with the disclosed architecture. As illustrated, the housing 102 is integrated as one unit comprising of a plurality of chambers for storing a plurality of components as also described above in the disclosure. The housing 102 can be designed in a variety of designs with different materials including, but not limited to iron, aluminum, steel, plastic, and more. The components; water reservoir 204, foam concentrate reservoir 212, air storage 216, aeration motor 218, and safety sensor 222 can be individually accessed and removed as per preferences of a user.

The placement of different components inside the housing 102 can vary and when the housing 102 is covered by a metal body, the components become weatherproof and can be positioned in any outdoor location.

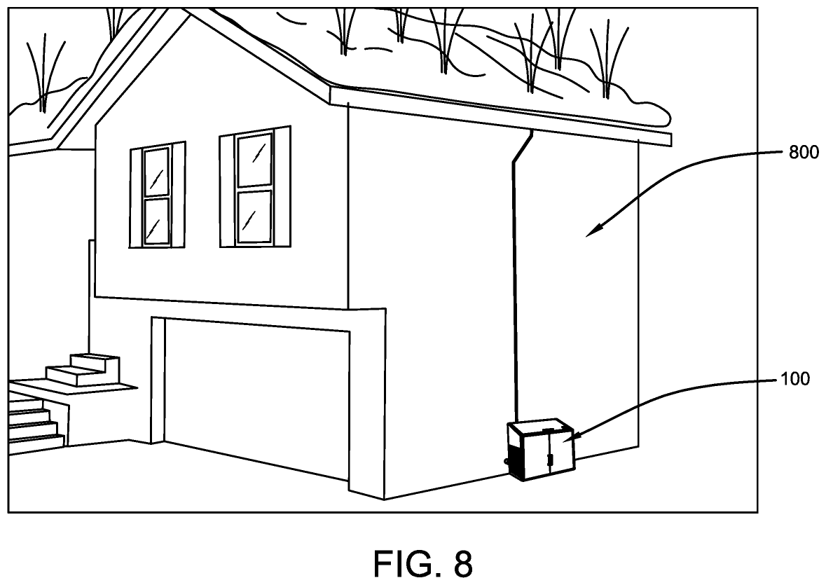

FIG. 8 illustrates a perspective view showing the fire suppression device installed outside a home for covering the home building with fire-retardant foam in accordance with the disclosed architecture. As illustrated, the device 100 is installed outside the home building 800 such that the multi-purpose sensor of the device 100 detects fire, smoke, or high temperature indicating a potential fire such that the device 100 autonomously creates and releases fire-retardant foam to cover the building 800, or portions thereof.

The device 100 can be installed with newly built buildings or can be coupled (i.e., retrofitted) to existing buildings. Further, the capacity of the device 100 can be adjusted to meet requirements of covering buildings of different sizes, structures, designated areas, rooms, fireplaces, cooking areas, et. Al. In different embodiments of the present invention, the device 100 can produce Class A foam and/or Class B foam. Class A foams can be specifically used for controlling wildfires and structure fires. Class B foams are used for flammable liquids and can be protein foams or synthetic foams.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “fire extinguishing device”, “autonomous fire extinguishing device”, “fire suppression device”, and “device” are interchangeable and refer to the autonomous fire suppression device 100 of the present invention.

Notwithstanding the forgoing, the autonomous fire suppression device 100 of the present invention can be of any suitable size and configuration as is known in the art without affecting the overall concept of the invention, provided that it accomplishes the above stated objectives. One of ordinary skill in the art will appreciate that the autonomous fire suppression device 100 as shown in the FIGS. are for illustrative purposes only, and that many other sizes and shapes of the autonomous fire suppression device 100 are well within the scope of the present disclosure. Although the dimensions of the autonomous fire suppression device 100 are important design parameters for user convenience, the autonomous fire suppression device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A fire suppression device for suppressing a fire, the fire suppression device comprising:
a housing comprising a first opening for accessing a first chamber and a second opening for accessing a second chamber;
a water reservoir, wherein said water reservoir is in said first chamber and comprises a quantity of water;
a foam concentrate reservoir, wherein said foam concentrate reservoir is in said second chamber and comprises a quantity of foam concentrate;
an air storage comprised of a third chamber housing a quantity of air;
an aeration motor positioned in the third chamber, wherein the aeration motor is configured to mix and aerate the quantity of water, the quantity of foam concentrate and the quantity of air to create a fire-retardant foam;
a discharge opening extending through the housing to an exterior of the housing; and
a plurality of sensors,
wherein the fire retardant foam exits the discharge opening to cover at least a portion of an exterior of a structure.

2. The fire suppression device of claim 1, wherein said aeration motor aerates in a pressurized manner for creating said fire-retardant foam.

3. The fire suppression device of claim 2, wherein said fire-retardant foam is discharged from said discharge opening when one of said plurality of sensors is actuated.

4. The fire suppression device of claim 3, wherein said wherein the fire retardant foam covers a fire when discharged.

5. The fire suppression device of claim 4, wherein the third chamber is disposed within the housing.

6. The fire suppression device of claim 5, wherein said housing is a weatherproof material comprising a metal or alloy.

7. The fire suppression device of claim 6, wherein said plurality of sensors is at least two sensors selected from a group of sensors consisting of a temperature sensor, a flame sensor, and a smoke detector.

8. The fire suppression device of claim 7, wherein said quantity of water is a distilled water.

9. The fire suppression device of claim 8, wherein said first opening is a lid having a display for displaying a current temperature and a status indicator.

10. The fire suppression device of claim 9, wherein said status indicator indicates a working status or a malfunctioning status.

11. The fire suppression device of claim 10, wherein said foam concentrate reservoir is a vacuum storage reservoir.

12. The fire suppression device of claim 10, wherein said foam concentrate reservoir is a storage of one or more chemicals selected from a group consisting of a hydrocarbon-based surfactant, a sodium alkyl sulfate, a fluorosurfactant, a fluorotelomer, a perfluorooctanoic acid (PFOA) and a perfluorooctanesulfonic acid (PFOS).

13. A fire suppression device for suppressing a fire, the fire suppression device comprising:
a housing;
a water reservoir;
a foam concentrate reservoir;
an air storage;
an aeration motor; and
a discharge opening extending through the housing to an exterior of the housing;
wherein said housing has a first opening for accessing a first chamber, a second opening for accessing a second chamber, and a third chamber;
wherein said water reservoir is in said first chamber and includes a store of water;
wherein said foam concentrate reservoir is in said second chamber and includes a store of foam concentrate;
wherein said air storage is disposed in the third chamber and includes a store of air;
wherein said third chamber has said aeration motor for mixing and aerating said water, said foam concentrate, and said air for creating a fire-retardant foam;
wherein the fire retardant foam exits the discharge opening to cover at least a portion of an exterior of a structure; and
further wherein said housing has a touch button for manually activating said fire suppression device to produce and release said fire-retardant foam.

14. (canceled)

15. The fire suppression device of claim 14, wherein said water reservoir, said foam concentrate reservoir, said air storage, and said aeration motor are internally connected via electric circuits to autonomously activate mixing and aerating said water, said foam concentrate, and said air for creating said fire-retardant foam and for discharging said fire-retardant foam from said discharge opening.

16. The fire suppression device of claim 15, wherein aerating is performed in a pressurized manner for creating said fire-retardant foam.

17. The fire suppression device of claim 15 further comprising a sensor, wherein said fire-retardant foam is discharged from said discharge opening when said sensor detects a threshold amount.

18. The fire suppression device of claim 17 wherein said sensor is selected from a group of sensors consisting of a temperature sensor, a flame sensor, and a smoke detector.

19. A method of suppressing a fire comprising the steps of:
forming a fire suppression device having a housing including a water reservoir, a foam concentrate reservoir, an air storage, an aeration motor, a discharge opening, and a sensor, the discharge opening extending through the housing to an exterior of the housing;
wherein said housing has hewing a first opening for accessing a first chamber and a second opening for accessing a second chamber;
wherein said water reservoir is in said first chamber and includes a store of water;
wherein said foam concentrate reservoir is in said second chamber and includes a store of foam concentrate;
wherein said air storage is disposed in a third chamber and includes a store of air;
actuating a mixing of said water, said foam concentrate, and said air when said sensor detects a threshold amount;
aerating said water, said foam concentrate, and said air for creating a fire-retardant foam; and
discharging said fire-retardant foam from said discharge opening to cover at least a portion of an exterior of a structure.

20. The method of suppressing a fire of claim 19, wherein said foam concentrate is one or more chemicals selected from a group consisting of a hydrocarbon-based surfactant, a sodium alkyl sulfate, a fluorosurfactant, a fluorotelomer, a perfluorooctanoic acid (PFOA), and a perfluorooctanesulfonic acid (PFOS).
